(19) United States
(12) Patent Application Publication
(10) Pub. No.: US 2024/0124355 A1
(43) Pub. Date: Apr. 18, 2024

(54) USE OF A MINERAL COMPONENT, SAND, WOOD FLOUR OR COMBINATIONS THEREOF FOR REDUCING THERMAL CONDUCTIVITY OF A MINERAL FOAM

(71) Applicant: HOLCIM TECHNOLOGY LTD, ZUG (CH)

(72) Inventors: Mélanie DYKMAN, HOLDERBANK (CH); Sébastien GEORGES, HOLDERBANK (CH); Patrick TINTILLIER, HOLDERBANK (CH)

(21) Appl. No.: 18/262,342

(22) PCT Filed: Jan. 28, 2022
(86) PCT No.: PCT/EP2022/052103

§ 371 Date: Jul. 20, 2023

(30) Foreign Application Priority Data
Jan. 29, 2021 (EP) 21305120.4

(51) Int. Cl. C04B 28/04; C04B 14/22; C04B 18/08; C04B 18/14; C04B 38/10

(52) U.S. Cl. CPC C04B 28/04; C04B 14/22; C04B 18/08; C04B 18/141; C04B 18/146; C04B 38/106; C04B 2201/32

(57) ABSTRACT

A method includes utilizing a component A selected from mineral component, sand, wood flour or combinations thereof, for reducing the thermal conductivity of a mineral foam produced by a including contacting a cement slurry and an aqueous foam, the cement composition used to prepare the cement slurry comprising the component A and Portland clinker.

### FIELD OF THE INVENTION

The present invention concerns a method for reducing the thermal conductivity of mineral foam.

### BACKGROUND OF THE INVENTION

Mineral foams are used in many technological applications. Due to their low thermal conductivity, good heat and fire resistance, and acoustic properties, this type of material is suitable for insulation applications in building construction and renovation.

A mineral foam is a concrete material in the form of foam. This material is generally more lightweight than typical concrete due to its pores or empty spaces. These pores or empty spaces are due to the presence of air in the mineral foam and they may be in the form of bubbles. An ultra-light foam is understood to be a foam generally having a density in its dry state of between 20 and 300 kg/m³.

Mineral foam may collapse due to a lack of stability in the mineral foam, for example during its placing or before it sets. These collapse problems of the foam may be due to coalescence phenomena, to Ostwald ripening phenomena, to hydrostatic pressure or to draining phenomena, the latter being greater in particular in case of elements of important height. The difficulty in the production of mineral foams is therefore to produce stable mineral foam which reduces these collapse problems. Examples of stable mineral foams are disclosed in the following applications: WO2017/093796, WO2017/093797, WO2017/093795, WO2019/229121, WO2020/039023.

Generally, a mineral foam is very advantageous for many applications due to its properties, such as its thermal insulation properties, its acoustic insulation properties, its durability, its resistance to fire and its easy implementation, especially compared to expanded polystyrene foams and other organic foams.

Reducing the thermal conductivity of mineral foam is essential for insulating materials. Reducing by only one milliwatt the thermal conductivity represents better insulation or less material thickness for the same insulation.

There is still a need for stable mineral foams having lower thermal conductivity, especially to be a viable alternative to expanded polystyrene foams, or other organic foams currently used.

### SUMMARY OF THE INVENTION

The invention is directed to the use of a component A selected from mineral component, sand, wood flour or combinations thereof, for reducing the thermal conductivity of a mineral foam produced by a process comprising a step of contacting a cement slurry and an aqueous foam, the cement composition used to prepare the cement slurry comprising the component A and Portland clinker.

The mineral component is preferably selected from slag, pozzolanic materials, fly ash, calcined schists, material containing calcium carbonate for example limestone, silica fume, siliceous component, metakaolin and mixtures thereof.

Preferably, the sand is composed of particles that have a size greater than 0 mm to 2 mm, preferably greater than 0 mm to 0.5 mm.

Preferably, the wood flour is composed of wood particles that have a D50 comprised between 0.1 to 200 μm.

Preferably, the cement composition comprises at least 20 wt.-%, preferably at least 30 wt.-%, more preferably at least 40 wt.-%, even more preferably at least 50 wt.-% of component A, compared to the total weight of the cement composition.

Component A can be selected from slag, limestone, wood flour and mixtures thereof. Component A can be selected from slag, limestone and mixtures thereof. Preferably, the cement composition comprises from 0 to 15 wt.-% of limestone and at least 36 wt.-% of slag, compared to the total weight of cement composition.

Component A can be selected from limestone, wood flour and mixtures thereof. Preferably, the cement composition comprises from 5 to 15 wt.-% of limestone and from 0.5 to 3 wt.-% of wood flour, compared to the total weight of cement composition.

The mineral component can be limestone. Preferably, the cement composition comprises at least 30 wt.-% of limestone, compared to the total weight of cement composition.

The mineral component can be silica fume. Preferably, the cement composition comprises from 10 and 20 wt.-% of silica fume, compared to the total weight of cement composition. The mineral component can be selected from ground glass, solid or hollow glass beads, glass granules, expanded glass powder, fly ash, and combinations thereof. Preferably, the cement composition comprises at least 30 wt.-% of the mineral addition, compared to the total weight of cement composition.

The component A can be a combination of material containing calcium carbonate and of component selected from pozzolanic materials, fly ash, slag, calcined schists, siliceous components, metakaolin, sand, wood flour or mixtures thereof. Preferably, the cement composition comprises from 5 to 15 wt.-% of material containing calcium carbonate and at least 30 wt.-%, preferably from 30 to 70 wt.-%, of component selected from pozzolanic materials, fly ash, slag, calcined schists, siliceous components, metakaolin, sand, wood flour or mixtures thereof, compared to the total weight of cement composition.

In the cement slurry, the weight water/cement composition ratio preferably ranges from 0.25 to 0.7, more preferably from 0.28 to 0.6, even more preferably from 0.29 to 0.45. The mineral foam can be produced by a process comprising the following steps:
separately preparing a cement slurry and an aqueous foam, the cement slurry comprises water and cement composition, wherein the cement composition used to prepare the cement slurry comprises Portland clinker and a component A as defined above;
contacting the cement slurry with the aqueous foam to obtain a foamed cement slurry;
casting the foamed cement slurry and leave it to set.

Preferably, the dry mineral foam has a dry density ranging from 20 to less than 500 kg/m³, preferably a dry density ranging from 20 to 300 kg/m³, more preferably a dry density ranging from 20 to 150 kg/m³, more preferably a dry density ranging from 20 to 100 kg/m³. The dry mineral foam has preferably a thermal conductivity ranging:
from 0.03 to 0.1 W/m·K for dry density ranging from 20 to 500 kg/m³, more preferably for dry density ranging from 20 to 300 kg/m³;
from 0.033 to 0.060 W/m·K for dry density ranging from 20 to 100 kg/m³.

### BRIEF DESCRIPTION OF THE DRAWINGS

The above and other objects, features and advantages of this invention will be apparent in the following detailed description of an illustrative embodiment thereof, with is to be read in connection with the accompanying drawing wherein:

FIG. 1 illustrates the thermal conductivity λ in function of the dry density of the mineral foam for mineral foams prepared with a cement slurry comprising 15 wt.-% or 30 wt.-% or 45 wt.-% or 60 wt.-% CEM I, 5 wt.-% calcium carbonate and at least 30 wt.-% of a mineral component selected from calcium carbonate (•), fly ash (▪ Cordemais fly ash, ▴ Carling fly ash) or ground glass (♦). For a same dry density, the thermal conductivity λ decreases when the mineral component content increase, whatever the amorphous content of the mineral component.

### DEFINITIONS

Cement: a cement is a hydraulic binder comprising at least 50% by weight of calcium oxide (CaO) and silicon dioxide (SiO₂). The cement comprises Portland clinker and calcium sulphate, and is preferably a Portland cement as defined in the standard NF-EN-197-1 of April 2012. The cements defined in standard NF-EN197-1 of April 2012 are grouped in 5 different families: CEM I, CEM II, CEM III, CEM IV and CEM V. In the present invention, the cement comprises Portland clinker and a mineral component. Accordingly, the cement is preferably chosen from the families CEM II, CEM III, CEM IV and CEM V. Alternatively, the cement can be a CEM I, CEM II, CEM III, CEM IV or CEM V to which mineral components are added prior to preparing the cement slurry. The cement may optionally further contain less than 10 wt.-% of a calcium aluminate cement or a calcium sulfoaluminate cement, compared to the total weight of the cement, if shorter setting times and higher early age strength development are for example required.

Mineral component: The mineral component comprises one or at least one of the components that are defined in paragraphs 5.2.2 to 5.2.7 of the same standard NF-EN197-1 of April 2012, ground steel slag, electric arc slag, metakaolin, or mixtures thereof.

Cement composition: composition comprising Portland clinker, calcium sulphate and a component A selected from mineral component, sand, wood flour or combinations thereof. When component A is mineral component, the cement composition is cement as defined above and the expression ‘cement’ and ‘cement composition’ can be used interchangeably. Hydraulic binder: material which sets and hardens by hydration. Setting is the changeover from the liquid or paste state to the solid state. Setting is followed or accompanied by a hardening phenomenon whereby the material acquires mechanical properties. Hardening generally occurs on completion of setting, in particular for cement.

Wood flour: powder made of ground wood particles

Cement slurry: The expression “cement slurry” designates a mixture comprising water and cement composition. That cement slurry may also comprise additional components, as disclosed below.

Aqueous foam: The expression “aqueous foam” designates a foam produced by combining water and a foaming agent then introducing a gas, generally air.

Foamed cement slurry: The expression “foamed cement slurry” designates a fresh foam comprising water and cement composition, mixed with gas bubbles, generally air. The foam will also comprise additional components, as disclosed below. The foamed cement slurry generally results from the mixing of a cement slurry and an aqueous foam. The foamed cement slurry is not produced from a gas-forming agent selected from hydrogen peroxide, peroxomonosulphuric acid, peroxodisulfphuric acid, alkaline peroxides, alkaline earth peroxides, organic peroxide, particles of aluminium, or mixtures thereof. The expressions “foamed cement slurry” and “fresh mineral foam” may be used interchangeably.

Mineral foam: a mineral foam is a set (i.e. hardened) foamed cement slurry. The expression “mineral foam” and “mineral cement foam” may be used interchangeably. The mineral foam of the invention is not an expanding foam, meaning is not a foam produced from a gas-forming agent selected from hydrogen peroxide, peroxomonosulphuric acid, peroxodisulfphuric acid, alkaline peroxides, alkaline earth peroxides, organic peroxide, particles of aluminium or mixtures thereof. The mineral foam of the invention has not been subjected to a thermal treatment (such as heating above 50° C.) and/or autoclave treatment (such as pressure above atmospheric pressure).

### DETAILED DESCRIPTION

It was discovered that substituting part of the Portland clinker with a mineral component, sand and/or a wood flour in a mineral foam reduces the thermal conductivity of the mineral foam. It has been discovered that at equal dry density of the mineral foam, thermal conductivity of the mineral foam decreases with increasing the substitution of Portland clinker with a mineral component and/or sand and/or wood flour. Surprisingly, the crystalline or amorphous nature of the mineral component and/or sand and/or wood flour has no or little effect on the thermal conductivity of the foam. On the contrary, increasing the amount of mineral component and/or sand and/or wood flour in the cement composition significatively impacts the thermal conductivity of the mineral foam.

The invention thus relates to the use of a component A selected from mineral component, sand, wood flour and combinations thereof, in a mineral foam comprising Portland clinker for reducing thermal conductivity of the mineral foam.

Specifically, the invention thus relates to the use of a component A selected from mineral component and/or sand and/or wood flour in the cement composition used to prepare the cement slurry for reducing thermal conductivity of a mineral foam. The mineral foam is produced by a process comprising a step of contacting the cement slurry and an aqueous foam.

In the invention, the cement composition comprises Portland clinker, component A and calcium sulphate. The cement composition is used to prepare a cement slurry comprising water and the cement. The cement composition is preferably the sole source of cement used to prepare the cement slurry.

In the description of the cement composition, the percentages of Portland clinker, component A and other component such as calcium sulphate will be expressed in weight compared to the total weight of the cement composition, i.e. compared to the total weight of Portland clinker, component A and component such as calcium sulphate.

Portland clinker is as defined in paragraph 5.2.1 of the standard NF-EN-197-1 of April 2012.

Advantageously, the cement has a Blaine specific surface ranging from 3000 to 10000 cm²/g, preferably from 3500 to 6000 cm²/g, more preferably from 3500 to 6000 cm²/g.

Calcium sulphate used according to the present invention includes gypsum (calcium sulphate dihydrate, CaSO₄.2H₂O), hemi-hydrate (CaSO₄.1/2H₂O), anhydrite (anhydrous calcium sulphate, CaSO₄) or a mixture thereof. Calcium sulphate produced as a by-product of certain industrial processes may also be used. Preferably, the calcium sulphate content ranges from 0% to 5% by weight of the cement, more preferably from 0.2% to 5% by weight of the cement.

The mineral component used according to the invention may be slag (for example, as defined in the European NF EN 197-1 Standard of April 2012, paragraph 5.2.2), pozzolanic materials (for example as defined in the European NF EN 197-1 Standard of April 2012, paragraph 5.2.3), fly ash (for example, as described in the European NF EN 197-1 Standard of April 2012, paragraph 5.2.4), calcined schists (for example, as described in the European NF EN 197-1 Standard of April 2012, paragraph 5.2.5), material containing calcium carbonate, for example limestone (for example, as defined in the European NF EN 197-1 Standard paragraph 5.2.6), limestone components (for example, as defined in the “Concrete” NF P 18-508 Standard), silica fume (for example, as defined in the European NF EN 197-1 Standard of April 2012, paragraph 5.2.7), siliceous components (for example, as defined in the “Concrete” NF P 18-509 Standard), metakaolin or mixtures thereof.

Examples of siliceous components are ground glass, solid or hollow glass beads, glass granules, expanded glass powder.

Fly ash is generally pulverulent particles comprised in fume from thermal power plants which are fed with coal. Fly ash is generally recovered by electrostatic or mechanical precipitation.

Slag is generally obtained by rapid cooling of molten slag resulting from melting of iron ore in a furnace. Ground granulated blast furnace slag is generally used. Slag can also be obtained by electric arc furnaces, and such slags are a non-metallic by-product that consists mainly of silicates and oxides formed during the process of refining the molten steel. The feed materials for electric arc furnace slags are mainly steel scrap and pig iron.

Silica fume may be a material obtained by the reduction of very pure quality quartz by the coal in electric arc furnaces used for the production of silicon and alloys of ferrosilicon.

Silica fume is generally formed of spherical particles comprising at least 85% by weight of amorphous silica.

The pozzolanic materials may be natural siliceous and/or silico-aluminous materials or a combination thereof. Among the pozzolanic materials, natural pozzolans can be mentioned, which are generally materials of volcanic origin or sedimentary rocks, and natural calcined pozzolans, which are materials of volcanic origin, clays, shale or thermally-activated sedimentary rocks.

All mineral components except silica fume are advantageously composed of particles that have a D50 generally comprised between 0.1 to 200 μm, preferably from 0.1 to 150 μm, more preferably from 1 μm and 100 μm.

In particular, all mineral components except silica fume comprise less than 1 wt.-% of ultrafine mineral particles with a D50 less than or equal to 1 μm, more particularly less than 0.5 wt.-%, the percentages being expressed by weight relative to the weight of the mineral components.

The D50, also noted as Dv50, corresponds to the 50th percentile of the size distribution of the particles, by volume; that is, 50% of the particles have a size that is less than or equal to D50 and 50% of the particles have a size that is greater than D50.

Silica fume comprises particles that have a D50 between 0.05 and 100 μm, preferably between 0.05 and 1 μm.

Sand is preferably a siliceous sand or a siliceous-calcareous sand.

Sand is preferably composed of particles that have a size greater than 0 mm to 2 mm (noted 0/2), preferably greater than 0 mm to 0.5 mm (noted 0/0.5). Wood flour is advantageously composed of powdered wood particles that have a D50 generally comprised between 0.1 to 200 μm, preferably from 0.1 to 150 μm, more preferably from 1 μm and 100 μm.

In the present invention, component A can be added to the cement composition prior or during the preparation of the cement slurry. Commercial cements, especially CEM III cements, can also be used.

Preferably, the cement composition comprises at least 20 wt.-%, preferably more than 20 wt.-%, preferably at least 30 wt.-%, more preferably at least 40 wt.-%, even more preferably at least 50 wt.-% of component A, the percentages are expressed in weight compared to the total weight of the cement composition.

Preferably, the cement composition comprises up to 85 wt.-% of component A, advantageously up to 80 wt.-% of component A or up to 70 wt.-% of component A, the percentages are expressed in weight compared to the total weight of the cement composition. In an embodiment, the cement slurry comprises up to 30 wt.-% of component A, the percentages are expressed in weight compared to the total weight of the cement composition.

In an embodiment, the cement slurry comprises more than 30 wt.-% to 50 wt.-% of component A, the percentages are expressed in weight compared to the total weight of the cement composition.

In an embodiment, the cement slurry comprises more than 50 wt.-% of component A, the percentages are expressed in weight compared to the total weight of the cement composition.

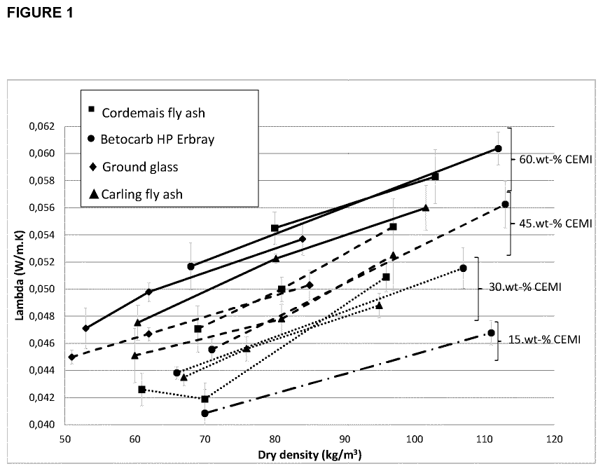

As shown in examples, especially in FIG. 1, the component A content will directly impact the thermal conductivity of the mineral foam for a given dry density.

Preferably, component A is selected from slag, limestone, wood flour and combinations thereof.

Preferably, component A is selected from slag or mixtures of slag and material containing calcium carbonate, for example limestone.

Preferably, component A is selected from wood flour, combinations of wood flour and material containing calcium carbonate, for example limestone, or combinations of wood flour, material containing calcium carbonate, for example limestone, and slag. Slag is preferably ground granulated blast furnace slag. Preferably, ground granulated blast furnace slag has a Blaine specific surface ranging from 2000 to 6000 cm²/g, preferably from 3000 to 5000 cm²/g.

Preferably the material containing calcium carbonate, for example limestone, is composed of particles that have a D50 generally comprised between 0.05 to 200 μm, preferably from 0.05 to 100 μm, more preferably from 0.1 μm to 10 μm.

The cement composition advantageously comprises 0 to 15 wt.-% of limestone and at least 30 wt.-% of slag, preferably from 30 to 80 wt.-% of slag, even more preferably from 36 to 80 wt.-% of slag, compared to the total weight of cement composition.

Preferably, the cement composition comprises from 5 to 15 wt.-% of limestone and at least wt.-% of slag. Preferably, the cement composition comprises from 5 to 15 wt.-% of limestone and from 30 to 75 wt.-% of slag, even more preferably from 36 to 75 wt.-% of slag, compared to the total weight of cement composition.

The cement composition advantageously comprises 0 to 15 wt.-% of limestone, preferably from 5 to 15 wt.-% of limestone, and at least 0.5 wt.-% of wood flour, preferably from 0.5 wt.-% to 10 wt.-% of wood flour, preferably from 0.5 wt.-% to 5 wt.-% of wood flour, preferably from 1 to 3 wt.-% of wood flour, compared to the total weight of cement composition. The composition preferably further comprises from 30 to 75 wt.-% of slag, compared to the total weight of cement composition.

Preferably, the component A comprises silica fume.

Preferably, the cement composition comprises from 5 and 20 wt.-% of silica fume, preferably from 10 to 20 wt.-% of silica fume, compared to the total weight of cement composition.

Preferably, the mineral component is selected from silica fume or mixtures of silica fume and material containing calcium carbonate, for example limestone.

Preferably the material containing calcium carbonate, for example limestone, is composed of particles that have a D50 generally comprised between 0.05 to 200 μm, preferably from 0.05 to 100 μm, more preferably from 0.1 μm to 10 μm.

The cement composition advantageously comprises from 0 to 15 wt.-% of limestone.

Preferably, component A is selected from ground glass, solid or hollow glass beads, glass granules, expanded glass powder, fly ash, slag obtained by electric arc furnaces, sand, wood flour and combinations thereof.

Preferably, the cement composition comprises at least 30 wt.-%, more preferably at least 40 wt.-%; more preferably at least 50 wt.-% of component A selected from ground glass, solid or hollow glass beads, glass granules, expanded glass powder, fly ash, slag obtained by electric arc furnaces, sand, wood flour and combinations thereof, compared to the total weight of the cement composition The cement composition may comprise up to 80 wt.-% of component A selected from ground glass, solid or hollow glass beads, glass granules, expanded glass powder, fly ash, slag obtained by electric arc furnaces, sand, wood flour and combinations thereof, compared to the total weight of the cement composition.

Preferably, component A is a material containing calcium carbonate, for example limestone. The cement composition advantageously comprises at least 30 wt.-%, more preferably at least 40 wt.-%, even more preferably at least 50 wt.-% of limestone. The cement composition may comprise up to 85 wt.-% of limestone.

Preferably the material containing calcium carbonate, for example limestone, is composed of particles that have a D50 generally comprised between 0.05 to 200 μm, preferably from 0.05 to 100 μm, more preferably from 0.1 μm to 10 μm.

The cement composition advantageously comprises from 0 to 15 wt.-% of a material containing calcium carbonate, for example limestone, having a D50 comprised between 0.05 to 100 μm and at least 30 wt.-%, preferably from 30 to 70 wt.-%, of a material containing calcium carbonate, for example limestone, having a D50 comprised between 0.5 to 20 μm, preferably comprised between 0.5 to 15 μm.

Preferably, component A is a combination of a material containing calcium carbonate and of a material selected from pozzolanic materials, fly ash, slag, calcined schists, siliceous components, metakaolin, sand, wood flour or mixtures thereof.

Preferably, the cement composition comprises from 5 to 15 wt.-% of a material containing calcium carbonate and at least 30 wt.-%, preferably from 30 to 70 wt.-%, of a component selected from pozzolanic materials, fly ash, slag, calcined schists, siliceous components, metakaolin, sand, wood flour or mixtures thereof.

The cement composition advantageously comprises 0.5 to 10 wt.-% of wood flour, preferably from 0.5 to 5 wt.-% of wood flour, preferably from 1 to 3 wt.-% of wood flour compared to the total weight of cement composition.

The cement composition advantageously comprises at least 30 wt.-% of slag, preferably, from 30 to 75 wt.-% of slag, even more preferably from 36 to 75 wt.-% of slag, compared to the total weight of cement composition.

Siliceous components are preferably chosen from ground glass, solid or hollow glass beads, glass granules, expanded glass powder and combinations thereof.

Preferably the material containing calcium carbonate, for example limestone, is composed of particles that have a D50 generally comprised between 0.05 to 200 μm, preferably from 0.05 to 100 μm, more preferably from 0.1 μm to 10 μm.

Cements that are less or not suitable for the realization of the invention are calcium aluminate cements and their mixtures used alone. Calcium aluminate cements are cements generally comprising a mineral phase C4A3$, CA, C12A7, C3A or C11A7CaF₂ or their mixtures, such as, e.g., Ciment Fondue (a calcium aluminate-based hydraulic binder), alumina cements, sulfoaluminate cements and calcium aluminate cements according to the European NF EN 14647 Standard of December 2006. Such cements are characterized by an alumina (Al₂O₃) content equal or lower than 35 wt.-%. However, calcium aluminate cements, calcium sulfoaluminate cements, or mixtures thereof, may be used in small amounts if for example shorter setting times or increased early age strength is desired. Calcium aluminate cements, calcium sulfoaluminate cements, or mixtures thereof, may not exceed 10 wt.-% of the total cement.

Accordingly, preferably, the cement of the invention has an alumina (Al₂O₃) content lower or equal to 35 wt.-%.

Advantageously, the cement consists in Portland clinker, mineral components, and optionally other components disclosed above.

Advantageously, the cement does not comprise other cements than the cements disclosed above.

The cement slurry used is typically a mixture comprising the cement composition, water, and that may include one or several chemical admixtures to adjust its rheological properties (such as a superplasticizer or a thickener) and to accelerate or retard the setting time of the cement.

The cement slurry does not comprise other cement or mineral addition than the components disclosed above in the description of the cement composition.

The water/cement composition ratio of the cement slurry used in step (i) is preferably from 0.25 to 0.7, more preferably from 0.28 to 0.6, even more preferably from 0.29 to 0.45.

The water/cement composition ratio may be modulated depending on the dry density of the mineral foam to be obtained. Advantageously, a cement slurry having a water/cement composition ratio from 0.29 and 0.34 is used to obtain low-dry density mineral foams, typically from 20 to 150 kg/m³. To obtain a mineral foam having a higher dry density, typically from 150 to 800 kg/m³, preferably from 300 to 400 kg/m³, a cement slurry having a water/cement composition ratio from 0.34 to 0.7, preferably from 0.34 to 0.6 is advantageously used.

The cement slurry may further comprise a water reducer, such as a plasticiser or a super-plasticiser. Preferably, the cement slurry comprises 0 to 1%, more preferably 0.05 to 0.5%, for example from 0.05% to 1% or 0.05% to 0.5%, of a water reducer, a plasticiser or a super-plasticiser, percentage expressed by weight relative to the dry cement composition weight.

A water reducer or plasticizer makes it possible to reduce the amount of mixing water for a given workability.

The water reducing agents include, for example lignosulfonates, hydroxycarboxylic acids, carbohydrates and other specialized organic compounds, e.g. glycerol, polyvinyl alcohol, sodium alumino-methyl-siliconate, sulfanilic acid and casein as well as superplasticizers. Superplasticizers can be selected from sulfonated condensates of naphthalene formaldehyde (generally a sodium salt), sulfonate condensates of melamine formaldehyde, modified lignosulfonates, polycarboxylates, e.g. polyacrylates (generally sodium salt), polycarboxylate ethers, copolymers containing a polyethylene glycol grafted on a polycarboxylate, sodium polycarboxylates-polysulfonates, and combinations thereof. In order to reduce the total amount of alkaline salts, the superplasticizer may be used as a calcium salt rather than as a sodium salt.

Preferably, the cement slurry does not comprise an anti-foaming agent, or any agent having the property of destabilizing an air/liquid emulsion. Certain commercial super-plasticisers may contain anti-foaming agents and consequently these super-plasticisers are not suitable for the cement slurry used to produce the mineral foam according to the invention.

Advantageously, the mineral foam is produced by a process comprising the following steps:
(i) separately preparing a cement slurry and an aqueous foam, the cement slurry comprises water and cement, wherein the cement used to prepare the cement slurry comprises Portland clinker and component A as defined previously;
(ii) contacting the cement slurry with the aqueous foam to obtain a foamed cement slurry;
(iii) casting the foamed cement slurry and leave it to set.

Preferably, the foamed cement slurry comprises a metal salt selected from aluminum, magnesium, lithium, calcium, or iron salt and mixtures thereof is added to the foamed cement slurry.

The metal salt is advantageously a metal sulphate.

An aluminium salt is preferred. Preferably, the aluminium salt is aluminium sulphate (Al₂(SO₄)₃).

The foamed cement slurry advantageously comprises from 0.15 wt.-% to 5 wt.-%, advantageously 0.15 wt.-% to 3 wt.-%, more advantageously 0.15 wt.-% to 1.5 wt.-% by weight of metal salt relative to the weight of cement composition.

The foamed cement slurry advantageously comprises from 0.01 wt.-% to 0.2 wt.-% of cellulose ether, advantageously 0.01% to 0.1% of cellulose ether, relative to the weight of cement composition. Advantageously, the cellulose ether is a nonionic cellulose ether or a mixture thereof. Methyl hydroxyethyl cellulose, a methyl hydroxypropyl cellulose, a methyl hydroxybutyl cellulose or mixtures thereof are preferred. Advantageously, the cellulose ether is a cellulose ether with delayed solubility

The foamed cement slurry may also comprise a foaming agent.

A foaming agent is generally a compound which modifies the superficial tension between two surfaces, in particular which lowers the superficial tension at the interface between a liquid and a gas, between a liquid and a solid or between two liquids. This compound is also called a surfactant.

The foaming agent may be selected from ionic, non-ionic, amphiphilic, amphoteric foaming agents and mixtures thereof. The ionic agent can be anionic or cationic.

The anionic surfactants may advantageously be selected from alkylethersulfonates, hydroxyalkylethersulfonates, alphaolefinesulfonates, alkylbenzenesulfonates, alkylester sulfonates, alkylethersulphates, hydroxyalkylethersulphates, alphaolefinesulphates, alkylbenzenesulphates, alkylamide sulphates, as well as their alkoxylated derivatives (in particular ethoxylated derivatives (EO) and/or propoxylated derivatives (PO)), fatty acid salts and/or their alkoxylated derivatives, in particular (EO) and/or (PO) (for example lauric acid, palmitic acid or stearic acid), alkylglycerol sulfonates, sulfonated polycarboxylic acids, paraffin sulfonates, N-akyl N-alkyltaurates, alkylphosphates, alkyletherphosphates, hydroxyalkyletherphosphates, alphaolefinephosphates, alkylbenzenephosphates, alkylamide phosphates, as well as their alkoxylated derivatives (in particular ethoxylated derivatives (EO) and/or propoxylated derivatives (PO)), alkylsuccinamates, alkylsulfosuccinates, monoesters or diesters of sulfosuccinates, sulphates of alkylglucosides, for example those in acid or lactone form and derivatives of I 17-hydroxyoctadecenic acid, or mixtures thereof.

The cationic surfactant can be a quaternary ammonium salt, an ethoxylated quaternary ammonium salt, an alkyl pyridinium salt, an alkyl imidazolium salt, and mixtures thereof. Preferably where the salt is a quaternary ammonium salt, it is selected from the group of monoalkyl trimethyl ammonium salts, dialkyl dimethyl ammonium salts and monoalkyl monobenzyl dimethyl ammonium salts. Preferably the counter ion is for example: bromide, chloride, acetate or methyl sulphate. The cationic surfactant can be for example quaternary ammonium salt Other suitable quaternary compounds include those containing a cyclic or aromatic structure such as lauryl pyridinium chloride and lauryl imidazolinium-chloride. A mixture of anionic surfactant and of cationic surfactant can be used.

The non-ionic surfactants may advantageously be selected from ethoxylated fatty acids, alkoxylated alkylphenols (in particular (EO) and/or (PO)), aliphatic alcohols, more particularly in C8-C22, products resulting from the condensation of ethylene oxide or propylene oxide with propylene glycol or ethylene glycol, products resulting from the condensation of ethylene oxide or propylene oxide with ethylene diamine, amides of alkoxylated fatty acids (in particular (EO) and/or (PO)), alkoxylated amines (in particular (EO) and/or (PO)), alkoxylated amidoamines (in particular (EO) and/or (PO)), amine oxides, alkoxylated terpenic hydrocarbons (in particular (EO) and/or (PO)), alkylpolyglucosides, polymers or amphiphilic oligomers, ethoxylated alcohols, esters of sorbitan or esters of oxyethylated sorbitan, or mixtures thereof.

The amphoteric surfactants may advantageously be selected from betaines, derivatives of imidazoline, polypeptides, lipoaminoacides or mixtures thereof. More particularly, suitable betaines according to the invention may be selected from cocamidopropyl betaine, dodecylic betaine, hexadecylic betaine and octadecylic betaine.

Amphiphilic surfactants may also be selected from polymers, oligomers or copolymers which are at least miscible in the aqueous phase. The amphiphilic polymers or oligomers may have a statistic distribution or a multi-block distribution. The amphiphilic polymers or oligomers may advantageously be selected from block polymers comprising at least one hydrophilic block and at least one hydrophobic block, the hydrophilic block being obtained from at least one non-ionic and/or anionic monomer. Amphiphilic polymers or oligomers may advantageously be selected from polysaccharides having hydrophobic groups, in particular alkyl groups, polyethylene glycol and its derivatives.

By way of example, the following amphiphilic polymers or oligomers may also be mentioned: three-block polyhydroxystearate polymers—polyethylene glycol-polyhydroxystearate or hydrophobic polyacrylamides.

Non-ionic amphiphilic polymers, and more particularly alkoxylated polymers (in particular (EO) and/or (PO)), are more preferably selected from polymers of which at least one part (at least 50% by weight) is miscible in water. Three-block polyethylene glycol/polypropylene glycol/polyethylene glycol polymer are preferred.

The foaming agent may also be a protein (such as keratin) or an organic protein derivative of animal origin (such as, e.g., the foaming agent named Propump26, a liquid mixture of hydrolysed keratin, sold by the company Propump Engineering Ltd) or of vegetable origin.

The foaming agents may also be a cationic surfactant (for example cetyltrimethylammonium bromide, CTAB), an ionic surfactant, an amphoteric surfactant (for example cocamidopropyl betaine, CAPB), or a nonionic surfactant, or mixtures thereof. Preferably, the foaming agent is a protein with a molecular weight of 1000 to 50 000 Daltons.

Preferably, the foaming agent is at a concentration of 0.15 to 1%, more preferably from 0.20 to 0.85%, by weight of foaming agent relative to the weight of foamed cement slurry. Even more preferably, the foamed cement slurry comprises at least 0.1% of foaming agent relative to the weight of foamed cement slurry. Most preferably, the foamed cement slurry comprises at least 0.3% of foaming agent relative to the weight of foamed cement slurry.

The foamed cement slurry may also comprise a co-stabilizer. The co-stabiliser is preferably a polyelectrolyte, in particular a polyanion.

The co-stabiliser is preferentially a polymer having constitutional unit derived from unsaturated carboxylic acid monomer or anhydride thereof. The carboxylic acid monomer can be monocarboxylic acid monomer or dicarboxylic acid monomer.

Examples Thereof Include:
acrylic acid, methacrylic acid; crotonic acid, maleic acid, fumaric acid, itaconic acid, and citraconic acid, and their monovalent metal salts, divalent metal salts, ammonium salts, and organic amine salts, and anhydride thereof;
esters, half esters and diesters of the above-mentioned unsaturated carboxylic acid monomers with alcohols having 1 to 12 carbon atoms, with alkoxy (poly)alkylene glycols, in particular with alkoxy (poly)ethylene glycol or with alkoxy (poly)propylene glycol;
amides, half amides and diamides of the above-mentioned unsaturated carboxylic acid monomers with amines having 1 to 30 carbon atoms, such as methyl(meth)acrylamide, (meth)acrylalkylamide, N-methylol(meth)acrylamide, and N,N-dimethyl(meth)acrylamide;
alkanediol of the above-mentioned unsaturated carboxylic acid monomers such as 1,4-butanediol mono(meth)acrylate, 1,5-pentanediol mono(meth)acrylate, and 1,6-hexanediol mono(meth)acrylate;
amines of the above-mentioned unsaturated carboxylic acid monomers such as aminoethyl (meth)acrylate, methylaminoethyl (meth)acrylate, dimethylaminoethyl (meth)acrylate, dimethylaminopropyl (meth)acrylate, and dibutylaminoethyl (meth)acrylate.

These monomers may be used either alone respectively or in combinations of two or more thereof. The monomer is in particular selected from acrylic acid, methacrylic acid, crotonic acid, maleic acid, fumaric acid, itaconic acid, and citraconic acid and anhydride thereof, in particular maleic anhydride, and mixtures thereof.

These monomers can also be copolymerised with hydrophobic monomers, in particular with:
vinyl aromatic monomers such as styrene, alpha-methylstyrene, vinyltoluene, and p-methylstyrene;
dienes such as butadiene, isoprene, 2-methyl-1,3-butadiene, and 2-chloro-1,3-butadiene;
1-alkenyl monomers having 2 to 12 carbon atoms, such as di-isobutylene.

The co-stabiliser is preferentially a copolymer of the above-mentioned unsaturated carboxylic acid monomers, or anhydride thereof, and of 1-alkenyl monomers having 2 to 12 carbon atoms, such as di-isobutylene. In particular the co-stabiliser is a copolymer of maleic anhydride and di-isobutylene.

The acid carboxylic function of the polymer is preferably totally or partially in a salt form. Advantageously the salt is a cation chosen from among the sodium, potassium, calcium, magnesium, ammonium, or their blends, preferentially chosen from among sodium or potassium and very preferentially sodium.

Preferably, the co-stabiliser is a sodium salt of a maleic anhydride copolymer, in particular a sodium salt of a maleic anhydride and di-isobutylene copolymer. A commercial product commercialised by Dow, TAMOL 731 A, was found to be suitable.

The foamed cement slurry may comprise a setting accelerator. Suitable accelerators may for example be selected from:
calcium salts, potassium salts and sodium salts wherein the anion may be nitrate, nitrite, chloride, formiate, thiocyanate, sulphate, bromide, carbonate or mixtures thereof;
alkali silicates and aluminates, for example sodium silicate, potassium silicate, sodium aluminate, potassium aluminate or mixtures thereof.

Preferably, the foamed cement slurry comprises 0.05 to 0.8 wt.-% of an accelerator, in % by weight relative to the weight of foamed cement slurry.

The foamed cement slurry may comprise a setting retarder. The retarder advantageously corresponds to the definition of the retarder mentioned in the European NF EN 934-2 Standard of September 2002. The retarder may for example be selected from:
sugars and derivative products, in particular, saccharose, glucose, sugar reducers (for example, lactose or maltose), cellobiose, gallactose or derivative products, for example, glucolactone;
carboxylic acids or salts thereof, in particular gluconic acid, gluconate, tartric acid, citric acid, gallic acid, glucoheptonic acid, saccharic acid or salicylic acid. The associated salts comprise, for example, ammonium salt, alkali metal salt (for example sodium salt or potassium salt), alkali earth metal salt (for example calcium salt or magnesium salt).

However, other salts may also be used;
phosphonic acids and salts thereof, in particular aminotri(methylenephosphonic) acid, pentasodic salt of aminotri(methylenephosphonic) acid, hexamethylene-diamine-tetra(methylene-phosphonic) acid, diethylene-triamine-penta(methylene-phosphonic acid and its sodium salt);
phosphates and their derivatives;
zinc salts, in particular zinc oxide, zinc borate and soluble zinc salts (nitrate, chloride);
borates, in particular boric acid, zinc borate and boron salts;
mixtures of these compounds.

The retarder may also be a carboxylic acid or a salt of carboxylic acid. Preferably, the retarder is a citric acid or a salt thereof.

The foamed cement slurry advantageously comprises 0.005 to 0.2% of retarder, more preferably 0.01 to 0.1%, in % by weight relative to the weight of foamed cement slurry.

The foamed cement slurry may comprise other additives. Such additives may be thickening agents, viscosity modifying agents, water retention agents, water repellent agents, air entraining agents, setting retarders, setting accelerators, coloured pigments, hollow glass beads, film forming agents, mineral components or their mixtures. Preferably, the additives do not comprise any defoaming agents.

Suitable water retention agents are preferably gums, cellulose or its derivatives, for example cellulose ethers or carboxy methyl cellulose, starch or its derivatives, gelatine, agar, carrageenan or bentonite clays.

In step (i), the cement slurry may be prepared using mixers typically used to produce cement slurries. They may be a mixer for slurries, a mixer from a cement batching plant, a mixer described in the European NF EN 196-1 Standard of April 2006 —Paragraph 4.4, or a beater with a planetary movement.

The cement slurry may be prepared in a continuous way.

In step (i), the aqueous foam may be produced by combining water and a foaming agent, then introducing a gas. This gas is preferably air. The foaming agent is preferably used in an amount of 0.25 to 5.00 wt.-%, preferably 0.4 to 2.0 wt.-%., even more preferably 0.4 to 1.00 wt.-% (dry weight) of the weight of water.

The introduction of air may be carried out by stirring, by bubbling or by injection under pressure. Preferably, the aqueous foam may be produced using a turbulent foamer (bed of glass beads for example). This type of foamer makes it possible to introduce air under pressure into an aqueous solution comprising a foaming agent.

The aqueous foam may be generated continuously.

The generated aqueous foam has air bubbles with a D50, which is less than or equal to 400 μm, preferably comprised from 100 to 400 μm, more preferably comprised from 150 to 300 μm. Preferably, the generated aqueous foam has air bubbles with a D50 which is 250 μm. The D50 of the bubbles is measured by back scattering. The apparatus used is the Turbiscan® Online provided by the Formulaction company. Measurements of the back scattering make it possible to estimate a D50 for the bubbles of an aqueous foam, by knowing beforehand the volume fraction of the bubbles and the refractive index of the solution of foaming agent.

The foaming agent is as disclosed above.

The aqueous foam may also comprise a co-stabiliser, as disclosed above.

In step (ii), the cement slurry may be homogenized with the aqueous foam by any means to obtain a foamed cement slurry. Preferably, step (ii) of the process may comprise the introduction of the cement slurry and the aqueous foam into a static mixer to obtain a foamed cement slurry.

The suitable static mixers preferably have elements in the form of a propeller to ensure complete radial mixing and successive divisions of the flow for each combination of liquids and gas. The suitable static mixers preferably have helical elements which transmit a radial speed to the fluid, which is directed alternatively towards the side of the mixer, then towards its centre. The successive combinations of elements directing the flow clockwise and counterclockwise provoke a change of direction and a division of the flow. These two combined actions increase the efficiency of the mixing. Preferably, the static mixer is a mixer operating by dividing the continuous flow of cement slurry and of aqueous foam. The homogeneity of the mix is based on the number of divisions. 16 elements are preferably used to ensure good homogeneity. The suitable static mixers are preferably those commercialised under the brand name of Kenics®.

Preferably, the cement slurry is pumped at a precise volume flow, which is a function of the composition of foamed cement slurry to be obtained. Then, this cement slurry is combined with the aqueous foam already circulating in the circuit of the process. The foamed cement slurry is thus generated. This foamed cement slurry is cast and left to set. Advantageously, the process does not need neither an autoclave step, nor a thermal treatment step (for example at 60-80° C.) in order to obtain a mineral foam. The method may be used in a discontinuous or continuous system.

To achieve this desired density, the weight ratio between the cement slurry and the aqueous foam is adjusted as done for mineral foam based on CEM I. Surprisingly, for a same density, the thermal conductivity decreases when the content of component A increases, component Areplacing part of the Portland clinker.

Thermal conductivity (also known as lambda (A)) is a physical magnitude characterizing the behavior of materials at the time of heat transfer via conduction. Thermal conductivity represents the amount of heat transferred per unit surface area and per unit of time under a temperature gradient. In the international unit system, thermal conductivity is expressed in watts per meter Kelvin (Wm⁻¹.K⁻¹).

The mineral foam obtained has preferably one or many of the following features:
The dry mineral foam has a dry density of less than 800 kg/m³, preferably a dry density of less than 600 kg/m³, more preferably a dry density ranging from 20 to less than 500 kg/m³, more preferably a dry density ranging from 20 to 300 kg/m³, more preferably a dry density ranging from 20 to 200 kg/m³, more preferably a dry density ranging from to 150 kg/m³, more preferably a dry density ranging from 20 to 100 kg/m³; more preferably a dry density ranging from 20 to 80 kg/m³;
The dry mineral foam has a thermal conductivity below 0.1 W/m·K, preferably below 0.09 W/m·K, more preferably below 0.08 W/m·K;
The dry mineral foam has a thermal conductivity ranging
   from 0.03 to 0.1 W/m·K for dry density ranging from 20 to 500 kg/m³, more preferably for dry density ranging from 20 to 300 kg/m³;
   from 0.033 to 0.065 W/m·K for dry density ranging from 20 to 150 kg/m³;
   from 0.033 to 0.060 W/m·K, preferably from 0.033 to 0.050 W/m·K, for dry density ranging from 20 to 100 kg/m³;
   from 0.033 to 0.055 W/m·K, preferably from 0.033 to 0.045 W/m·K, for dry density ranging from 20 to 80 kg/m³.

The method has preferably one or more of the following characteristics:
the method is universal, which is to say it makes it possible to produce a stable mineral foam from any type of cement;
the method is easy to implement and to use at an industrial scale;
the method can be easily transported to any site;
the method makes it possible to implement a mineral foam in a continuous manner. It is therefore possible to produce the mineral foam continuously and to pour this foam without interruption.

The mineral foam provided by the instant invention has preferably one or more of the following characteristics:
the setting time of the mineral foam is short and generally around 2 hours less compared to foam based on slurry based on Portland clinker alone;
the mineral foam according to the invention has excellent stability properties. In particular, it is possible to obtain foam that does not slump or only very slightly when the foam is poured vertically or from a considerable height. For example, the mineral foam according to the invention did not slump or only very slightly when it is poured vertically from a height greater than or equal to 2 meters;
the high stability of the mineral foam makes the preparation of lightweight mineral foams possible;
the mineral foam according to the invention has excellent thermal properties, and in particular very low thermal conductivity compared to known mineral foams having a similar dry density. It is highly desirable to reduce thermal conductivity in construction materials since this makes it possible to obtain savings of heating energy for residence and office buildings. Furthermore, this decrease makes it possible to reduce thermal bridges, in particular in the construction of buildings several stories high and designed using indoor thermal insulation. In particular thermal bridges are reduced on the intermediary flours.

Surprisingly, the quantity of Portland clinker is lowered but the mechanical resistance of the mineral foam does not sharply decrease.

The presence of mineral components makes it possible to obtain homogeneous, regular foam. The quantity of CSH (cement hydrates) decreases and the thermal conductivity is improved without degrading proportionally the other properties of the mineral foam: stability, mechanical strength, . . .

The combined use of material containing calcium carbonate and at least another mineral component in a mineral foam is also new as such. Accordingly, the invention is also directed to mineral foam obtained by a process comprising the following steps:
(i) separately preparing a cement slurry and an aqueous foam, the cement slurry comprises water and cement composition, wherein the cement composition used to prepare the cement slurry comprises Portland clinker and from 5 to 15 wt.-% of material containing calcium carbonate and at least 30 wt.-% of component selected from pozzolanic materials, fly ash, slag, calcined schists, siliceous components, metakaolin, mixtures of silica fume with at least one of these mineral components (pozzolanic materials, fly ash, slag, calcined schists, siliceous components, metakaolin), sand, wood flour or mixtures thereof;
(ii) contacting the cement slurry with the aqueous foam to obtain a foamed cement slurry;
(iii) casting the foamed cement slurry and leave it to set.

The mineral component, sand, wood flour and the material containing calcium carbonate, for example limestone, are as defined above and their content in the cement slurry are as defined above. When silica fume is present, its content is preferably less than 20 wt.-% compare to the total weight of the cement composition. The mineral component can in particular be slag. The cement slurry and the foamed cement slurry can further comprise the components disclosed above.

The mineral foam provided by the instant invention has the characteristics previously described, in particular the setting time, the stability, the dry density, the thermal conductivity, the combination dry density/thermal conductivity previously described. The use of 10 to 20 wt.-% silica fume in a mineral foam is also new as such. Accordingly, the invention is also directed to mineral foam obtained by a process comprising the following steps:
(i) separately preparing a cement slurry and an aqueous foam, the cement slurry comprises water and cement composition, wherein the cement used to prepare the cement slurry comprises Portland clinker and from 10 to 20 wt.-% of silica fume;
(ii) contacting the cement slurry with the aqueous foam to obtain a foamed cement slurry;
(iii) casting the foamed cement slurry and leave it to set.

Silica fume is as defined above and its content in the cement slurry is as defined above. Other mineral components, as disclosed above, sand and/or wood flour can further be added. The cement slurry and the foamed cement can further comprise the components disclosed above.

The mineral foam provided by the instant invention has the characteristics previously described, in particular the setting time, the stability, the dry density, the thermal conductivity, the combination dry density/thermal conductivity previously described.

The use of more than 50 wt.-% of component A in a mineral foam is also new as such. Accordingly, the invention is also directed to mineral foam obtained by a process comprising the following steps:
(i) separately preparing a cement slurry and an aqueous foam, the cement slurry comprises water and cement composition, wherein the cement composition used to prepare the cement slurry comprises Portland clinker and more than 50 wt.-% of component A;
(ii) contacting the cement slurry with the aqueous foam to obtain a foamed cement slurry;
(iii) casting the foamed cement slurry and leave it to set.

The component A is as defined above.

The cement composition advantageously comprises at least 30 wt.-% of slag, preferably from 30 to 80 wt.-% of slag, even more preferably from 36 to 80 wt.-% of slag, compared to the total weight of cement composition. When slag content is above 50 wt.-%, it can be the sole component A.

The cement composition advantageously comprises from 5 to 85 wt.-% of a material containing calcium carbonate, for example limestone, compared to the total weight of the cement composition. The cement composition advantageously comprises at least 30 wt.-%, more preferably at least 40 wt.-%, even more preferably at least 50 wt.-% of limestone. The cement composition advantageously comprises from 5 to 15 wt.-% of a material containing calcium carbonate, for example limestone, compared to the total weight of the cement composition. When limestone content is above 50 wt.-%, it can be the sole component A. The cement composition advantageously from 0 to 10 wt.-% of wood flour, preferably from 0.5 to 10 wt.-% of wood flour, preferably from 0.5 to 5 wt.-% of wood flour, preferably from 1 to 3 wt.-% of wood flour, compared to the total weight of cement composition. The cement composition will comprise at least another component A.

The cement composition advantageously comprises from 0 to 50 wt.-% of sand, preferably from 10 to 20 wt.-% of sand, compared to the total weight of cement composition. The cement composition will comprise at least another component A.

The cement composition advantageously comprises from 0 and 20 wt.-% of silica fume, preferably from 5 to 20 wt.-% of silica fume, compared to the total weight of cement composition. The cement composition will comprise at least another component A.

The cement composition advantageously comprises at least 30 wt.-%, more preferably at least 40 wt.-%; more preferably at least 50 wt.-% of component selected from ground glass, solid or hollow glass beads, glass granules, expanded glass powder, fly ash, slag obtained by electric arc furnaces and combinations thereof, compared to the total weight of the cement composition. When its content is above 50 wt.-%, it can be the sole component A. The component A can in particular be slag, fly ash, material containing calcium carbonate, for example limestone, sand, wood flour, and combinations thereof.

The cement slurry and the foamed cement can further comprise the components disclosed above.

The mineral foam provided by the instant invention has the characteristics previously described, in particular the setting time, the stability, the dry density, the thermal conductivity, the combination dry density/thermal conductivity previously described.

The combined use of sand and at least one mineral component, and optionally wood flour, in a mineral foam is also new as such. Accordingly, the invention is also directed to mineral foam obtained by a process comprising the following steps:
(i) separately preparing a cement slurry and an aqueous foam, the cement slurry comprises water and cement composition, wherein the cement composition used to prepare the cement slurry comprises Portland clinker, sand, at least 10 wt.-% of a mineral component selected from pozzolanic materials, fly ash, slag, calcined schists, siliceous components, metakaolin, material containing calcium carbonate, mixtures of silica fume with at least one of these mineral components or mixtures thereof, and optionally wood flour;
(ii) contacting the cement slurry with the aqueous foam to obtain a foamed cement slurry;
(iii) casting the foamed cement slurry and leave it to set.

Sand content is preferably from 10 to 50 wt.-%, more preferably from 10 to 30 wt.-%, compared to the total weight of the cement composition.

The mineral component, sand and wood flour are as defined above. Preferably the cement composition comprises at least 30 wt.-% of mineral component, compared to the total weight of the cement composition.

The cement composition advantageously comprises at least 30 wt.-% of slag, preferably from 30 to 80 wt.-% of slag, even more preferably from 36 to 80 wt.-% of slag, compared to the total weight of cement composition.

The cement composition advantageously comprises from 5 to 85 wt.-% of a material containing calcium carbonate, for example limestone, compared to the total weight of the cement composition. The cement composition advantageously comprises at least 30 wt.-%, more preferably at least 40 wt.-%, even more preferably at least 50 wt.-% of limestone. The cement composition advantageously comprises from 5 to 15 wt.-% of a material containing calcium carbonate, for example limestone, compared to the total weight of the cement composition.

The cement composition advantageously from 0 to 10 wt.-% of wood flour, 0.5 to 10 wt.-% of wood flour, preferably from 0.5 to 5 wt.-% of wood flour, preferably from 1 to 3 wt.-% of wood flour, compared to the total weight of cement composition.

The cement composition advantageously comprises from 0 and 20 wt.-% of silica fume, preferably from 5 to 20 wt.-% of silica fume, compared to the total weight of cement composition.

The cement composition advantageously comprises at least 30 wt.-%, more preferably at least 40 wt.-%; more preferably at least 50 wt.-% of component selected from ground glass, solid or hollow glass beads, glass granules, expanded glass powder, fly ash, slag obtained by electric arc furnaces and combinations thereof, compared to the total weight of the cement composition.

The mineral component can in particular be slag or mixtures of slag and limestone.

The cement slurry and the foamed cement slurry can further comprise the components disclosed above.

The mineral foam provided by the instant invention has the characteristics previously described, in particular the setting time, the stability, the dry density, the thermal conductivity, the combination dry density/thermal conductivity previously described.

The use of wood flour in a mineral foam is also new as such. Accordingly, the invention is also directed to mineral foam obtained by a process comprising the following steps:
(i) separately preparing a cement slurry and an aqueous foam, the cement slurry comprises water and cement composition, wherein the cement composition used to prepare the cement slurry comprises Portland clinker, wood flour, at least 10 wt.-% of mineral component selected from pozzolanic materials, fly ash, slag, calcined schists, siliceous components, metakaolin, material containing calcium carbonate, mixtures of silica fume with at least one of these mineral components or mixtures thereof, and optionally sand;
(ii) contacting the cement slurry with the aqueous foam to obtain a foamed cement slurry;
(iii) casting the foamed cement slurry and leave it to set.

Wood flour content is preferably from 0.5 to 10 wt.-%, preferably from 0.5 to 5 wt.-% of wood flour, preferably from 1 to 3 wt.-% of wood flour, compared to the total weight of the cement composition.

The mineral component, sand and wood flour are as defined above. Preferably the cement composition comprises at least 30 wt.-% of mineral component, compared to the total weight of the cement composition.

The cement composition advantageously comprises at least 30 wt.-% of slag, preferably from 30 to 80 wt.-% of slag, even more preferably from 36 to 80 wt.-% of slag, compared to the total weight of cement composition.

The cement composition advantageously comprises from 5 to 85 wt.-% of a material containing calcium carbonate, for example limestone, compared to the total weight of the cement composition. The cement composition advantageously comprises at least 30 wt.-%, more preferably at least 40 wt.-%, even more preferably at least 50 wt.-% of limestone. The cement composition advantageously comprises from 5 to 15 wt.-% of a material containing calcium carbonate, for example limestone, compared to the total weight of the cement composition.

The cement composition advantageously from 0 to 50 wt.-% of sand, preferably from 10 to 20 wt.-% of sand, compared to the total weight of cement composition.

The cement composition advantageously comprises from 0 and 20 wt.-% of silica fume, preferably from 5 to 10 wt.-% of silica fume, compared to the total weight of cement composition.

The cement composition advantageously comprises at least 30 wt.-%, more preferably at least 40 wt.-%; more preferably at least 50 wt.-% of component selected from ground glass, solid or hollow glass beads, glass granules, expanded glass powder, fly ash, slag obtained by electric arc furnaces and combinations thereof, compared to the total weight of the cement composition.

The mineral component can in particular be slag or mixtures of slag and limestone. The cement slurry and the foamed cement slurry can further comprise the components disclosed above.

The mineral foam provided by the instant invention has the characteristics previously described, in particular the setting time, the stability, the dry density, the thermal conductivity, the combination dry density/thermal conductivity previously described.

The following examples illustrate the invention.

Measurements

The measuring methods used are now detailed below.

Laser Granulometry Method

In this specification, including the accompanying claims, particle size distributions and particle sizes are as measured using a laser granulometer of the type Mastersize 2000 (year 2008, series MALI 020429) sold by the company Malvern.

Measurement is carried out in an appropriate medium (for example an aqueous medium for non-reactive particles, or alcohol for reactive material) in order to disperse the particles. The particle size shall be in the range of 1 μm to 2 mm. The light source consists of a red He—Ne laser (632 nm) and a blue diode (466 nm). The optical model is that of Frauenhofer and the calculation matrix is of the polydisperse type. A background noise measurement is effected with a pump speed of 2000 rpm, a stirrer speed of 800 rpm and a noise measurement for 10 s, in absence of ultrasound. It is verified that the luminous intensity of the laser is at least equal to 80% and that a decreasing exponential curve is obtained for the background noise. If this is not the case, the cell's lenses have to be cleaned.

Subsequently, a first measurement is performed on the sample with the following parameters: pump speed 2000 rpm and stirrer speed 800 rpm. The sample is introduced in order to establish an obscuration between 10 and 20%. After stabilisation of the obscuration, the measurement is carried out with a duration between the immersion and the measurement being fixed to 10 s. The duration of the measurement is 30 s (30000 analysed diffraction images). In the obtained granulogram one has to take into account that a portion of the powder may be agglomerated.

Subsequently, a second measurement is carried out (without emptying the receptacle) with ultrasound. The pump speed is set to 2500 rpm, the stirrer speed is set to 1000 rpm, the ultrasound is emitted at 100% (30 watts). This setting is maintained for 3 minutes, afterwards the initial settings are resumed: pump speed at 2000 rpm, stirrer speed at 800 rpm, no ultrasound. At the end of 10 s (for possible air bubbles to clear), a measurement is carried out for 30 s (30000 analysed images). This second measurement corresponds to a powder desagglomerated by an ultrasonic dispersion.

Each measurement is repeated at least twice to verify the stability of the result.

Measurement of the specific BLAINE surface

The specific surface of the various materials is measured as follows. The Blaine method is used at a temperature of 20° C. with a relative humidity not exceeding 65%, wherein a Blaine apparatus Euromatest Sintco conforming to the European Standard EN 196-6 is used.

Prior to the measurement the humid samples are dried in a drying chamber to obtain a constant weight at a temperature of 50-150° C. The dried product is then ground in order to obtain a powder having a maximum particle size of less than or equal to 80 μm.

Measurement of Thermal Conductivity

To measure thermal conductivity, two measuring devices are used: The CT-meter and the guarded hot plate.

Thermal conductivity was measured using a thermal conductivity measuring device: the CT-metre (Resistance 5Ω, probe wire 50 mm). The samples were dried in a drying oven at 45° C. until their weight remained constant. The sample was then cut into two equal pieces using a saw. The measurement probe was placed between the two flat sides of these two half samples (the sawed sides). Heat was transmitted from the source towards the thermocouple through the material surrounding the probe. The rise in temperature of the thermocouple was measured over time and the thermal conductivity of the sample was calculated.

Thermal conductivity was measured using a thermal conductivity measuring device: the guarded hot plate, TAURUS TLP 500 GX-1. The measurement has been validated for samples whose thermal conductivity is between 0.0295 and 0.6 W/(m.K) and whose compressive strength on the sample surface is greater than 200N. The samples were dried in a drying oven at 45° C. and 10% relative humidity, until their weight remined constant (difference less than 0.1 kg/m^{3/24} h) The sample is placed between two contact plates containing the thermocouples and the cold faces and the hot faces are applied with a precharge of 125 N. For density less than 60 kg/m³ the preload is 62.5 N. The heat flux between hot plate and cold plate is measured at 10° C., 20° C. and 30° C. Thermal conductivity is calculated at 10° C. by linear regression from measurements at target average temperatures of 10° C., 20° C., 30° C.

### EXAMPLES

### Example 1

The cement used in this example is a Portland cement produced at the Lafarge cement production site of Saint Pierre La Cour, in France. It is a CEM I 52.5N Portland cement having a Blaine specific surface of 6340 cm²/g.

The Mineral Components Comprise:
calcium carbonate supplied by IMERYS under the brand name Socal 31 wherein the D50 is 75+/−25 nm;
calcium carbonate supplied by OMYA under the brand name Betocarb HP Erbray wherein the D50 is 17 μm
Carling fly ash from the Carling thermal power plant in Moselle, France, wherein the D50 is 58 μm. Carling fly ash has an amorphous content, determined by X-ray diffractometry, using the Rielveld method with a PANalytical diffractometer, of 55 wt.-%.
Cordemais fly ash from the Cordemais thermal plant in Loire Atlantique, France, wherein the D50 is 30 μm. Cordemais fly ash has an amorphous content, determined by X-ray diffractometry, using the Rielveld method with a PANalytical diffractometer, of 32 wt.-%.
Ground glass has an amorphous content, determined by X-ray diffractometry, using the Rielveld method with a PANalytical diffractometer, of 100 wt.-%.
Anhydrite

The foaming agent is the Propump 26, an animal protein from the Propum company; the average molecular weight of Propump 26 is 6000 Daltons.

The following cement compositions (in wt.-%) have been prepared:

TABLE 1

| | | Beto- | Car- | | | | |
|---|---|---|---|---|---|---|---|
| | CEM | carb HP | ling | Cordemais | Anhy- | Ground | Socal |
| | I | Erbray | fly ash | fly ash | drite | glass | 31 |
| C11 | 60.00 | 33.47 | — | — | 1.53 | — | 5.00 |
| C12 | 45.00 | 48.85 | — | — | 1.15 | — | 5.00 |
| C13 | 30.00 | 64.23 | — | — | 0.77 | — | 5.00 |
| C14 | 15.00 | 79.62 | — | — | 0.38 | — | 5.00 |
| C21 | 60.00 | — | 33.47 | — | 1.53 | — | 5.00 |
| C22 | 45.00 | — | 48.85 | — | 1.15 | — | 5.00 |
| C23 | 30.00 | — | 64.23 | — | 0.77 | — | 5.00 |
| C31 | 60.00 | — | — | 33.47 | 1.53 | — | 5.00 |
| C32 | 45.00 | — | — | 48.85 | 1.15 | — | 5.00 |
| C33 | 30.00 | — | — | 64.23 | 0.77 | — | 5.00 |
| C41 | 60.00 | — | — | — | 1.53 | 33.47 | 5.00 |
| C42 | 45.00 | — | — | — | 1.15 | 48.85 | 5.00 |

A cement slurry is prepared using PREMIA 162 superplasticizer, supplied by Chryso, France. PREMIA 162 is a polycarboxylate superplasticizer that does not contain any defoaming agent, that has a dry content of 25 wt.-%.

The water/cement or water/solid ratio depends on the water demand of the components. The ratios used are given in table 2

TABLE 2

| | Water/cement weight | Premia 162 dosage in | Premia 162 dosage in |
|---|---|---|---|
| | ratio | dry wt.-% of the cement | wt.-% of the cement |
| C11 | 0.28 | 0.42 | 1.68 |
| C12 | 0.28 | 0.45 | 1.80 |
| C13 | 0.28 | 0.5 | 2.00 |
| C14 | 0.28 | 0.8 | 3.20 |
| C21 | 0.27 | 0.6 | 2.40 |
| C22 | 0.28 | 0.7 | 2.80 |
| C23 | 0.28 | 0.85 | 3.40 |
| C31 | 0.28 | 0.65 | 2.60 |
| C32 | 0.29 | 0.7 | 2.80 |
| C33 | 0.31 | 0.85 | 3.40 |
| C41 | 0.27 | 0.59 | 2.36 |
| C42 | 0.28 | 0.62 | 2.48 |

The cement slurry is mixed with an aqueous foam comprising Propump P26 at 45 g/L and sodium sulphate at 25 g/L, for 3 wet densities of mineral foams: 100 kg/m³, 125 kg/m³ and 150 kg/m³. The wet density corresponds to the density of the foamed cement slurry immediately after casting.

Thermal conductivity in function of the dry density is reported on FIG. 1.

In FIG. 1, it can be seen that all the mineral foams based on a cement slurry comprising 60 wt.-% of CEM I, compare to the total weight of cement are grouped together, whatever the nature and the crystallinity of the mineral component.

Below, we see the group of mineral foams based on a cement slurry comprising 45 wt.-% of CEM I, compare to the total weight of cement then the curves of mineral foams based on a cement slurry comprising 30 wt.-% of CEM I, compare to the total weight of cement and finally the curve of the mineral foam based on a cement slurry comprising 15 wt.-% of CEM I, compare to the total weight of cement.

The thermal conductivity is here dependent on the amount of cement (and therefore on the amount of mineral component) but it is independent of the crystallinity of the mineral component.

### Example 2

The cement used in this example is a Portland cement produced at the Lafarge cement production site of Le Teil, in France. It is a CEM I 52.5R Portland cement having a Blaine specific surface of 4300 cm²/g (standard deviation 150 m²/g).

The mineral component is a limestone supplied by the company La Provencale under the tradename Mikhart 1 having a D50 of 1.7 μm.

The plasticizer is Bind′R supplied by the company Mapei, a polycarboxylate based plasticizer having a solid content of 30±2 wt. %.

The foaming agent used is MAPEAIR L/LA supplied by the company MAPEI, having a solids content of 26 wt.-%.

The following cement slurries are prepared (quantities in g for one litre):

TABLE 3

| Cement slurry | CEM I | Limestone | Plasticizer | Water |
|---|---|---|---|---|
| Reference | 1401 | 156 | 7.4 | 493 |
| C1 | 1061 | 469 | 7.8 | 484 |
| C2 | 753 | 753 | 7.7 | 476 |

A foaming solution, i.e., an aqueous solution containing the foaming agents, is prepared using the following amounts of materials.

For one liter of foaming solution:

| | | |
|---|---|---|
| MAPEAIR L/LA | 25 | g |
| Tap water | 975 | g |

The foaming solution is pumped by means of a volumetric pump having an eccentric screw conveyor Seed TM MD-006-24 (commission no: 278702).

This foaming solution is introduced into the foamer through the bed of beads by means of pressurized air (1-6 bar) and a T-junction. The aqueous foam is produced in a continuous way at a rate of 8 litres per minute, having a density of 45 kg/m³.

The aqueous foam is brought into contact with the cement slurry each other in a static mixer and a foamed cement slurry was obtained.

The slurry rate is adjusted to obtain the target density.

The following mineral foams are obtained.

TABLE 4

| | | Dry density | |
|---|---|---|---|
| Mineral foam | Cement slurry | (kg/m³) | λ (10° C.) W/m · K |
| REF1 | Reference | 60.00 | 0.0366 |
| REF2 | Reference | 64.90 | 0.0385 |
| REF3 | Reference | 68.00 | 0.0388 |
| INV1 | C1 | 63.38 | 0.0369 |
| INV2 | C1 | 68.78 | 0.0380 |
| INV3 | C2 | 59.60 | 0.0357 |
| INV4 | C2 | 64.40 | 0.0365 |

### Example 3

The cement used in the reference is a Portland cement produced at the Lafarge cement production site of Le Teil, in France. It is a CEM I 52.5R Portland cement having a Blaine specific surface of 4300 cm²/g (standard deviation 150 m²/g). The cement used in the example (CEMIII) is Portland cement produced at the Lafarge cement production site comprising 40 wt.-% of slag, having a Blaine specific surface of 4630 cm²/g.

The reference and the example further comprise a limestone supplied by the company La Provencale under the tradename Mikhart 1 having a D50 of 1.7 μm.

The plasticizer is Bind′R supplied by the company Mapei, a polycarboxylate plasticizer having a solid content of 30±2 wt. %.

The foaming agent used is MAPEAIR L/LA supplied by the company MAPEI, having a solids content of 26 wt.-%.

The following cement slurries are prepared (quantities in g for one litre):

TABLE 5

| Cement slurry | CEM I | CEM III | Limestone | Plasticizer | Water |
|---|---|---|---|---|---|
| Reference | 1401 | — | 156 | 7.4 | 493 |
| C1 | — | 1355 | 157 | 7.2 | 482 |
| C2 | — | 1365 | 157 | 6.5 | 482 |

A foaming solution, i.e., an aqueous solution containing the foaming agents, is prepared using the following amounts of materials.

For one litre of foaming solution:

| | |
|---|---|
| MAPEAIR L/LA | 25 g |
| Tap water | 975 g |

The foaming solution is pumped by means of a volumetric pump having an eccentric screw conveyor Seed TM MD-006-24 (commission no: 278702).

This foaming solution is introduced into the foamer through the bed of beads by means of pressurized air (1-6 bar) and a T-junction. The aqueous foam is produced in a continuous way at a rate of 8 litres per minute, having a density of 45 kg/m³.

The aqueous foam is brought into contact with the cement slurry each other in a static mixer and a foamed cement slurry was obtained.

The slurry rate is adjusted to obtain the target density.

The following mineral foams are obtained.

TABLE 6

| Mineral | Cement | Dry density | λ (10° C.) |
|---|---|---|---|
| foam | slurry | (kg/m³) | W/m · K |
| REF1 | Reference | 70.00 | 0.0386 |
| REF2 | Reference | 111.41 | 0.0493 |
| INV1 | C1 | 69.48 | 0.0363 |
| INV2 | C1 | 73.66 | 0.0366 |
| INV3 | C1 | 120.30 | 0.0461 |
| INV4 | C1 | 117.50 | 0.0459 |
| INV5 | C2 | 69.50 | 0.0371 |
| INV6 | C2 | 42.80 | 0.0345 |

### Example 4

The cement used in this example is a Portland cement produced at the Lafarge cement production site of Le Teil, in France. It is a CEM I 52.5R Portland cement having a Blaine specific surface of 4300 cm²/g (standard deviation 150 cm²/g).

The mineral component is a grey silica fume from society RIMA-Industrial, Brazil having a BET value of 18.4 m²/g.

The plasticizer is Bind′R supplied by the company Mapei, a polycarboxylate plasticizer having a solid content of 30±2 wt. %.

The foaming agent used is MAPEAIR L/LA supplied by the company MAPEI, having a solids content of 26 wt.-%.

The following cement slurry is prepared (quantities in g for one litre):

TABLE 7

| Cement | CEM | Silica | | |
|---|---|---|---|---|
| slurry | I | fume | Plasticizer | Water |
| C1 | 1003 | 248 | 8.2 | 570 |

A foaming solution, i.e., an aqueous solution containing the foaming agents, is prepared using the following amounts of materials.

For one litre of foaming solution:

| | |
|---|---|
| MAPEAIR L/LA | 25 g |
| Tap water | 975 g |

The foaming solution is pumped by means of a volumetric pump having an eccentric screw conveyor Seed TM MD-006-24 (commission no: 278702).

This foaming solution is introduced into the foamer through the bed of beads by means of pressurized air (1-6 bar) and a T-junction. The aqueous foam is produced in a continuous way at a rate of 8 litres per minute, having a density of 45 kg/m³. The aqueous foam is brought into contact with the cement slurry each other in a static mixer and a foamed cement slurry was obtained.

The slurry rate is adjusted to obtain the target density.

The following mineral foams are obtained.

TABLE 8

| | | | |
|---|---|---|---|
| Mineral | Cement | Dry density | λ (10° C.) |
| foam | slurry | (kg/m³) | W/m · K |

| | | |
|---|---|---|
| C1 | 67.50 | 0.0365 |
| C1 | 71.64 | 0.0370 |

### Example 5

The cement used in this example is a Portland cement produced at the Lafarge cement production site of Le Teil, in France (it is a CEM III/A 52.5 Portland cement comprising 40 wt.-% of slag) or a Portland cement produced at the Lafarge cement production site of La Malle (it is a CEM III/B 42.5N Portland cement comprising 70 wt.-% slag). The plasticizer is Bind′R supplied by the company Mapei, a polycarboxylate plasticizer having a solid content of 30±2 wt. %.

The foaming agent used is MAPEAIR L/LA supplied by the company MAPEI, having a solids content of 26 wt.-%.

The following cement slurries are prepared (quantities in g for one litre):

TABLE 9

| Cement | CEM | CEM | | |
|---|---|---|---|---|
| slurry | III/A | III/B | Plasticizer | Water |
| C1 | 1531 | — | 7.3 | 485 |
| C2 | 1531 | — | 6.5 | 485 |
| C3 | — | 1531 | 5 | 486 |

A foaming solution, i.e., an aqueous solution containing the foaming agents, is prepared using the following amounts of materials.

For one liter of foaming solution:

| | |
|---|---|
| MAPEAIR L/LA | 25 g |
| Tap water | 975 g |

The foaming solution is pumped by means of a volumetric pump having an eccentric screw conveyor Seed TM MD-006-24 (commission no: 278702).

This foaming solution is introduced into the foamer through the bed of beads by means of pressurized air (1-6 bar) and a T-junction. The aqueous foam is produced in a continuous way at a rate of 8 litres per minute, having a density of 45 kg/m³.

The aqueous foam is brought into contact with the cement slurry each other in a static mixer and a foamed cement slurry was obtained.

The slurry rate is adjusted to obtain the target density.

The following mineral foams are obtained.

TABLE 10

| Mineral | Cement | Dry density | λ (10° C.) |
|---|---|---|---|
| foam | slurry | (kg/m³) | W/m · K |
| INV1 | C1 | 70.56 | 0.0361 |
| INV2 | C1 | 76.00 | 0.0371 |
| INV3 | C2 | 55.00 | 0.0348 |
| INV4 | C2 | 64.10 | 0.0359 |
| INV5 | C2 | 73.00 | 0.0372 |
| INV6 | C3 | 65.10 | 0.0359 |
| INV7 | C3 | 69.30 | 0.0366 |

### Example 6

The cement used in this example is a CEM III/B Portland cement comprising 70 wt.-% slag.

Limestone is supplied by the company La Provencale under the tradename Mikhart 1 having a D50 of 1.7 μm.

The plasticizer is Bind′R supplied by the company Mapei, a polycarboxylate plasticizer having a solid content of 30±2 wt. %.

The foaming agent used is MAPEAIR L/LA supplied by the company MAPEI, having a solids content of 26 wt.-%.

The following cement slurry is prepared (quantities in g for one litre):

TABLE 11

| Cement | CEM | | | |
|---|---|---|---|---|
| slurry | III/B | Limestone | Plasticizer | Water |
| C1 | 1365 | 157 | 4.9 | 483.5 |

A foaming solution, i.e., an aqueous solution containing the foaming agents, is prepared using the following amounts of materials.

For one liter of foaming solution:

| | |
|---|---|
| MAPEAIR L/LA | 25 g |
| Tap water | 975 g |

The foaming solution is pumped by means of a volumetric pump having an eccentric screw conveyor Seed TM MD-006-24 (commission no: 278702).

This foaming solution is introduced into the foamer through the bed of beads by means of pressurized air (1-6 bar) and a T-junction. The aqueous foam is produced in a continuous way at a rate of 8 litres per minute, having a density of 45 kg/m³.

The aqueous foam is brought into contact with the cement slurry each other in a static mixer and a foamed cement slurry was obtained.

The slurry rate is adjusted to obtain the target density.

The following mineral foam is obtained.

TABLE 12

| Mineral | Cement | Dry density | λ (10° C.) |
|---|---|---|---|
| foam | slurry | (kg/m³) | W/m · K |
| INV1 | C1 | 63.0 | 0.0357 |

### Example 7

The cement used in this example is a CEM I Portland cement having a Blaine specific surface of 4000 cm²/g.

Slag is ground blast furnace slag having the following particle size characteristics: D10=2.1 μm, D50=23.6 μm, D90=254.8 μm.

Limestone is supplied by the company La Provencale under the tradename Mikhart 1 having a D50 of 1.7 μm.

The plasticizer is Bind′R supplied by the company Mapei, a polycarboxylate plasticizer having a solid content of 30±2 wt. %.

The foaming agent used is MAPEAIR L/LA supplied by the company MAPEI, having a solids content of 26 wt.-%.

The following cement slurry is prepared (quantities in g for one litre):

TABLE 13

| Cement | | | | | | |
|---|---|---|---|---|---|---|
| slurry | CEM I | Slag | Gypsum | Limestone | Plasticizer | Water |
| C1 | 588 | 382 | 19 | 110 | 7.2 | 369 |

A foaming solution, i.e., an aqueous solution containing the foaming agents, is prepared using the following amounts of materials.

For one liter of foaming solution:

| | |
|---|---|
| MAPEAIR L/LA | 25 g |
| Tap water | 975 g |

The foaming solution is pumped by means of a volumetric pump having an eccentric screw conveyor Seed TM MD-006-24 (commission no: 278702).

This foaming solution is introduced into the foamer through the bed of beads by means of pressurized air (1-6 bar) and a T-junction. The aqueous foam is produced in a continuous way at a rate of 8 litres per minute, having a density of 45 kg/m³.

The aqueous foam is brought into contact with the cement slurry each other in a static mixer and a foamed cement slurry was obtained.

The slurry rate is adjusted to obtain the target density.

The following mineral foam is obtained.

TABLE 14

| Mineral | Cement | Dry density | λ (10° C.) |
|---|---|---|---|
| foam | slurry | (kg/m³) | W/m · K |
| INV1 | C1 | 72.2 | 0.0362 |

### Example 8

The cement used in this example is a CEM I 52.5 Portland cement or a CEM III/B Portland cement comprising 70% wt. % slag.

The examples further comprise a limestone supplied by the company La Provencale under the tradename Mikhart 1 having a D50 of 1.7 μm.

The plasticizer is Bind′R supplied by the company Mapei, a polycarboxylate plasticizer having a solid content of 30±2 wt. %.

The wood flour is a fine powder of wood whose particles have a D50 below 200 μm.

The foaming agent used is MAPEAIR L/LA supplied by the company MAPEI, having a solids content of 26 wt.-%.

The following cement slurries are prepared (quantities in g for one litre):

TABLE 15

| Cement | CEM | CEM | | Wood | | |
|---|---|---|---|---|---|---|
| slurry | I | III | Limestone | flour | Plasticizer | Water |
| C1 | 1348 | | 150 | 13 | 8.2 | 478 |
| C2 | 1250 | | 139 | 43 | 8.4 | 453 |
| C3 | — | 1274 | 145 | 30 | 6.9 | 458 |

A foaming solution, i.e., an aqueous solution containing the foaming agents, is prepared using the following amounts of materials.

For one liter of foaming solution:

| | |
|---|---|
| MAPEAIR L/LA | 25 g |
| Tap water | 975 g |

The foaming solution is pumped by means of a volumetric pump having an eccentric screw conveyor Seed TM MD-006-24 (commission no: 278702).

This foaming solution is introduced into the foamer through the bed of beads by means of pressurized air (1-6 bar) and a T-junction. The aqueous foam is produced in a continuous way at a rate of 8 litres per minute, having a density of 45 kg/m³.

The aqueous foam is brought into contact with the cement slurry each other in a static mixer and a foamed cement slurry was obtained.

The slurry rate is adjusted to obtain the target density.

The following mineral foams are obtained.

TABLE 16

| Mineral | Cement | Dry density | λ (10° C.) |
|---|---|---|---|
| foam | slurry | (kg/m³) | W/m · K |
| INV1 | C1 | 68.9 | 0.0378 |
| INV2 | C2 | 65.9 | 0.0372 |
| INV3 | C3 | 62.2 | 0.0358 |

1. A method comprising utilizing a component A selected from mineral component, sand, wood flour or combinations thereof, for reducing the thermal conductivity of a mineral foam produced by a process comprising a step of contacting a cement slurry and an aqueous foam, the cement composition used to prepare the cement slurry comprising the component A and Portland clinker.

2. The method according to claim 1, wherein the mineral component is selected from slag, pozzolanic materials, fly ash, calcined schists, material containing calcium carbonate, silica fume, siliceous component, metakaolin and mixtures thereof.

3. The method according to claim 1, wherein the sand is composed of particles that have a size greater than 0 mm to 2 mm.

4. The method according to claim 1, wherein the wood flour is composed of wood particles that have a D50 comprised between 0.1 to 200 μm.

5. The method according to claim 1, wherein the cement composition comprises at least 20 wt. %, of component A, compared to the total weight of the cement composition.

6. The method according to claim 1, wherein the component A is selected from slag, limestone, wood flour and mixtures thereof.

7. The method according to claim 6, wherein the cement composition comprises from 0 to 15 wt.-% of limestone and at least 36 wt.-% of slag, compared to the total weight of cement composition.

8. The method according to claim 6, wherein the cement composition comprises from 5 to 15 wt.-% of limestone and from 0.5 to 3 wt.-% of wood flour, compared to the total weight of cement composition.

9. The method according to claim 6, wherein the mineral component is limestone and the cement composition comprises at least 30 wt.-% of limestone, compared to the total weight of cement composition.

10. The method according to claim 1, wherein the mineral component is silica fume and the cement composition comprises from 10 and 20 wt.-% of silica fume, compared to the total weight of cement composition.

11. The method according to claim 1, wherein the mineral component is selected from ground glass, solid or hollow glass beads, glass granules, expanded glass powder, fly ash, and combinations thereof and the cement composition comprises at least 30 wt.-% of the mineral addition, compared to the total weight of cement composition.

12. The method according to claim 1, wherein the component A is a combination of material containing calcium carbonate and of component selected from pozzolanic materials, fly ash, slag, calcined schists, siliceous components, metakaolin, sand, wood flour or mixtures thereof.

13. The method according to claim 12, wherein the cement composition comprises from 5 to 15 wt.-% of material containing calcium carbonate and at least 30 wt. % of component selected from pozzolanic materials, fly ash, slag, calcined schists, siliceous components, metakaolin, sand, wood flour or mixtures thereof, compared to the total weight of cement composition.

14. The method according to claim 1, wherein in the cement slurry, weight water/cement composition ratio ranges from 0.25 to 0.7.

15. The method according to claim 1, wherein the mineral foam is produced by a process comprising:
separately preparing a cement slurry and an aqueous foam, the cement slurry comprises water and cement composition, wherein the cement composition used to prepare the cement slurry comprises Portland clinker and a component A as defined in claim 1;
contacting the cement slurry with the aqueous foam to obtain a foamed cement slurry; and
casting the foamed cement slurry and leave it to set.

16. The method according to claim 1, wherein the dry mineral foam has a dry density ranging from 20 to less than 500 kg/m³.

17. The method according to claim 1, wherein the dry mineral foam has a thermal conductivity ranging
from 0.03 to 0.1 W/m·K for dry density ranging from 20 to 500 kg/m³;
from 0.033 to 0.060 W/m·K for dry density ranging from 20 to 100 kg/m³.

18. The method according to claim 5, wherein the cement composition comprises at least 50 wt.-% of component A, compared to the total weight of the cement composition.

19. The method according to claim 16, wherein the dry mineral foam has a dry density ranging from 20 to 100 kg/m³.
